(19) United States
(12) Patent Application Publication
(10) Pub. No.: US 2011/0253666 A1
(43) Pub. Date: Oct. 20, 2011

(54) LINER-STRETCHING BOTTLE CLOSURE BODY RECESS AND REINFORCING INSERT

(76) Inventor: Timothy P. KELLER, Winters, CA (US)

(21) Appl. No.: 13/051,968

(22) Filed: Mar. 18, 2011

Related U.S. Application Data
(60) Provisional application No. 61/315,517, filed on Mar. 19, 2010.

(51) Int. Cl. B65D 53/04; B67B 3/18; B67B 6/00; B65D 41/04

(52) U.S. Cl. 215/350; 215/329; 53/485; 53/490

(57) ABSTRACT

A bottle closure includes a cap having a cylindrical shaped body and a closed end. The bottle closure further includes a liner disposed on an interior surface of the closed end of the cap, the liner for contacting a bottle opening. The closed end of the cap further includes a recess formed therein for urging a central portion of the liner into a bottle opening when applied thereto (e.g., by a bottling press). The bottle closure may further include or have applied thereto a support structure or central mass to support the recess during the bottling process and thereafter.

### CROSS-REFERENCE TO RELATED APPLICATION

This application claims priority from U.S. Provisional application No. 61/315,517, filed Mar. 19, 2010, entitled LINER-STRETCHING BOTTLE CLOSURE BODY RECESS AND REINFORCING INSERT which is hereby incorporated by reference in its entirety and for all purposes.

### BACKGROUND

1. Field

This application relates generally to bottle closures, and more specifically to a bottle closure having a recess for positioning a liner or gasket within the bore or neck of a bottle.

2. Related Art

It is common practice for a bottle closure to consist of two general pieces: a disc-shaped gasket (also referred to as a liner) that fits across the mouth of the bottle and a rigid body which attaches to the bottle and holds the gasket in place so as to firmly seal the bottle.

Although many closures form their seals merely at the perpendicular contact point of the bottle lip and the gasket, some designs modify their geometry so as to curve this contact area around the outside lip of the container and provide a larger contact patch and a more robust seal.

For closures that are not very deep, mold-in-place gaskets are often used that include a semi-circular cross section to similarly provide a larger contact area around the rim's inner lip. This is often observable on the inside of crown-type closures used for conventional beer bottles.

For longer closures (deeper than ˜40 mm) the creation of a mold-in-place gasket becomes difficult to execute, and inserted liners are typically used instead. These gaskets are typically punched from a sheet of laminated foam and barrier layers.

For these inserted liners, the curving of the liner is normally accomplished during the application of the closure, whereby a flat liner is forced to wrap around the outside of the bottle lip via pressure from a capping head. The closure or bottling industry typically refers to this process as a “re-draw” because the external body of the cap was formed by drawing an aluminum plate over a die into a tube shaped shell and at application, the shell is drawn downward a second time in order to wrap the inserted liner down around the lip of the bottle to create a larger contact area between the liner and the bottle lip.

Although the redraw of screwcap type closures decreases the possibility of a fluid leak, it does little to improve the consistency of oxygen-barrier performance of the seal and may actually promote oxygen variability in these closures. This may be due to the process of forcing an area of the liner that has a large radius into a smaller radius, thereby introducing wrinkles into the liner. This pleating effect can be envisioned as how a sheet of paper would react if it were used to seal the end of a tube: the disc of material at the end may remain flat, but the paper would have to fold in order conform to the sides of the tube.

For inserted liners which normally use a foam backing, these wrinkles tend to form at the center of one of the cells in the foam, using the cavity in the foam as a void into which the wrinkle can fall as the surface of the liner folds itself. Further, for inserted liners, these wrinkles can be microscopic, but even microscopic wrinkles can provide a channel across the surface of the liner through which air can pass and work its way into the inside of the bottle.

An additional problem with the current art arises from the fact that the external edge of the closure is so important to that closure's integrity. Mechanical damage to the outside lip of the bottle after it is capped may damage the seal within, thereby changing the oxygen transfer properties or even allowing a fluid leak.

### BRIEF SUMMARY OF THE INVENTION

According to one aspect of the present invention, a beverage cap is provided that includes a recessed area at the top-center of the cap that forces the liner therein to engage with the inner lip and bore of the sealed container, as well as a reinforcing insert contained therein which aids in the packages' durability and security. In one example, the recess and insert forces the liner to engage the bottle in a more robust manner which is less likely to form wrinkles and less susceptible to mechanical damage since the most critical area of sealing contact is moved to the protected inner lip of the bottle neck.

In one example, a bottle closure includes a cap having a cylindrical shaped body and a closed end. The bottle closure further includes a liner disposed on an interior surface of the closed end of the cap, the liner for contacting a bottle opening. The closed end of the cap further includes a recess formed therein for urging a central portion of the liner into a bottle opening when applied thereto (e.g., by a bottling press). The bottle closure may further include or have applied thereto a support structure or central mass to support the recess during the bottling process and thereafter.

In another example, a bottle closure includes a cap having a cylindrical shaped body and a closed end, and a liner disposed on an interior surface of the closed end of the cap, the liner for contacting a bottle opening. The closed end of the cap further including at least one of a recess or central mass formed therein for urging a central portion of the liner into a bottle opening when applied thereto.

In another example, a method for capping or closing a bottle is provided. The method may include disposing a cap having a cylindrical shaped body and a closed end over a bottle opening, the closed end having at least one of a recess or central mass formed therein, the cap further including a liner disposed on an interior surface of the closed end. The method further including urging the cap against the bottle opening such that a central portion of the liner contacts inner walls of the bottle opening. The method may further include urging the cap with a press having a feature to support the at least one of a recess or central mass.

Exemplary bottle closures may include a recess or mass that is centered with respect to the closed end of the cap and is .5 to 2 millimeters deep and .5 to 2 millimeters narrower in diameter than a lip of a bottle being capped, or where the recess or mass is centered with respect to the closed end of the cap and is .5 to 2 millimeters deep and 1.5 to 15 millimeters narrower in diameter than the cylindrical shaped body of the cap. The recess or mass used in the exemplary closures may have a semi-circular, ellipsoidal, trapezoidal, or rectangular cross-sectional profile.

Exemplary support structures may include plastic, glass, wax, adhesive, metal, paper, cork, or the like, and may further be operable to allow oxygen access to at least one hole formed in the cap and within the recess itself (e.g., via a physical pathway for gas to reach the at least one hole or permeation through the material of the support structure to the at least one hole).

### BRIEF DESCRIPTION OF THE DRAWINGS

The present application can be best understood by reference to the following description taken in conjunction with the accompanying drawing figures, in which like parts may be referred to by like numerals.

FIG. 1 illustrates a cross-sectional view of a related bottle closure having a liner, both before and after application to bottle;

FIG. 2 illustrates cross-sectional views of an embodiment of a bottle closure having a an inserted liner;

FIG. 3 illustrates a cross-sectional view of another embodiment of a bottle closure having a pre-molded liner and reinforcing structure insert;

FIG. 4 illustrates a cross-sectional view of the embodiments detailed by FIGS. 2 and 4 when applied to the bottle.

FIGS. 5A and 5B illustrate perspective views of an embodiment of a bottle closure having a recessed liner a partial cut away of the bottle closure positioned on a bottle neck;

FIG. 6 illustrates a perspective view of a reinforcing structure insert for use with a bottle closure; and

FIG. 7 illustrates a cross-sectional view of a liner showing variable height for receiving a linear and fitting within a retaining groove of a bottle neck.

### DETAILED DESCRIPTION OF THE INVENTION

The following description sets forth numerous specific configurations, parameters, and the like. It should be recognized, however, that such description is not intended as a limitation on the scope of the present invention, but is instead provided as a description of exemplary embodiments.

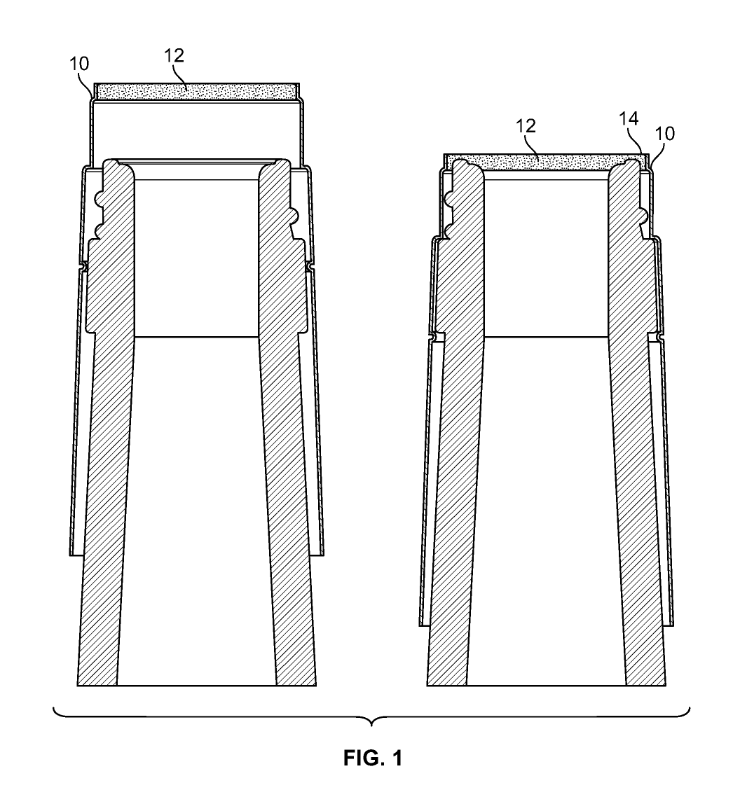

FIG. 1 illustrates a cross-sectional view of a related bottle closure 10 having a liner 12. Bottle closure 10 generally comprises a cylindrical shaped housing, closed at one end, and includes liner 12 disposed on the upper interior surface of the closed end thereof. As closure 10 is disposed over a bottle opening as shown, liner 12 contacts the bottle opening, generally at the top of the bottle opening or lip, and may be compressed there against, thereby forming a closure over the bottle opening. As described, the process of closing bottle closure 10, and compressing liner 12, may cause undesirable crimping of liner 12 at edge 14. Such crimping may compromise the seal, or in the case of semi-permeable seals, affect the permeable characteristics in unpredictable manners.

Producing a closure that provides reliable and consistent oxygen transfer properties generally requires an adequately mated sealing surface with limited microscopic surface defects. Examples provided herein may produce a more reliable sealing surface than previously available while adhering to a standard form factor closure generally used by the bottling industry.

In one embodiment provided herein, a circular recessed area in the body of a bottle closure that extends the contact area of the cap liner or gasket into the inner bore of the sealed bottle neck is provided. When an elastomeric gasket or “liner” is inserted into the cap body and applied to the bottle, the surface of the liner is forced to stretch into contact with both the inner bore of the bottle neck as well as the top surface of the bottle neck, thereby forming a consistent and smooth sealing contact area in tight interface with two surfaces of the bottle (i.e., the inner neck surface and the top surface). This recess also provides accommodation for an optional reinforcing insert inside the recess to ensure the appropriate application of the closure as well as enhance the image of the package, and protect any ventilation holes that the cap may employ within the recessed area.

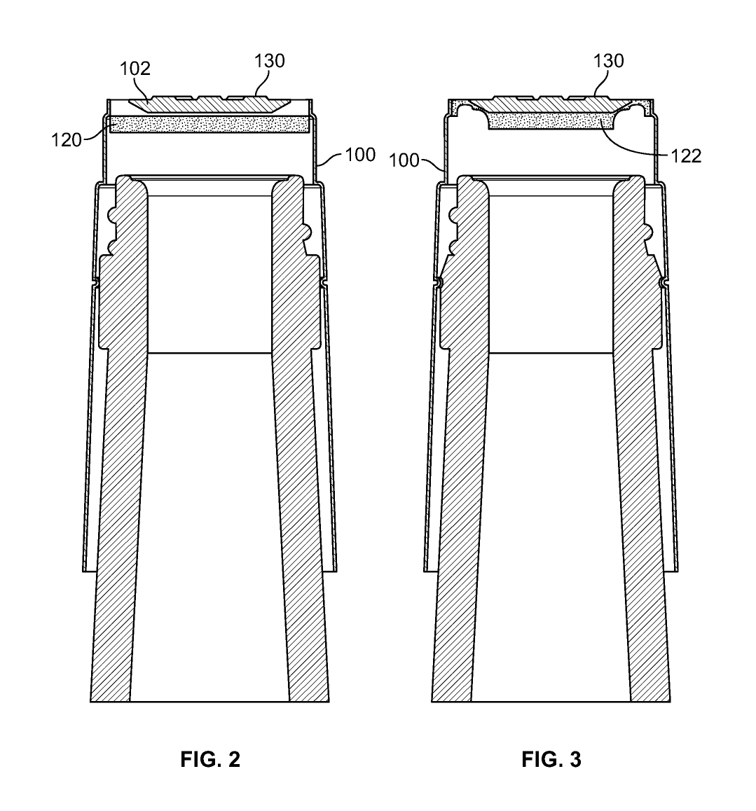

FIG. 2 illustrates a cross-sectional view of an embodiment of a bottle closure 100, having a recessed portion 102 and a sealing liner 120. In particular, liner 120 may be substantially planar prior to capping a bottle and closure 100 includes a recessed portion 102 formed therein to urge or force the liner to wrap and deform to the bottle opening when pressed onto the bottle during the capping process. The pressure for the compression of liner 120 and its molding into a final shape similar to that of 121 is provided by the capping head and this pressure is retained by the crimping of the metal closure body to the threads and retaining ring 104 of the closed bottle itself.

In one example, recessed portion 102 is located in the center of the closed end of closure 100, and recessed portion 102 is further sized for urging liner 120 within the opening of the bottle being sealed. As the recess portion 102, centered with liner 120, is pushed down into the mouth of the bottle being sealed during a closing process, an intermediate section of the liner is stretched across the inner-side and rim of the bottle. This motion is essentially the reverse of the aforementioned redraw process as it requires the liner to be stretched as opposed to being crimped-down (see, for example, FIG. 1).

The benefit of this reversal is that the stretching of liner 120 may produce a contact area that is both smooth, and formed to the inside mating surface of the bottle. For example, the result is that the liner 120 may have an increased surface area in contact with the bottle, but is free of surface wrinkles that induce variability in the oxygen barrier properties of the closure. As an additional benefit, this interior contact area of the liner is generally protected from mechanical damage (because it is within the bottle bore opening) and further reduces the compromise of the seal during product handling after the bottle is sealed.

In one example, the recess portion 102 is from .25 to 4 millimeters deep and is .5 to 2 millimeters narrower in diameter than the inside lip of the bottle being sealed. These dimensions may vary depending on the thickness, compressibility, and ductility of the inserted liner 120 being used as well as the bottle opening. Additionally, the recess portion may have various profiles in cross section, including circular, ellipsoidal, polygonal, and so on.

In some examples, and for certain materials or bottle characteristics, during application of closure 100 to a bottle, the bottle will exert counter-pressure on the recess portion 102 in an upward and/or inward direction as the liner 120 resists it's intended stretching. In embodiments wherein the rigidity of the metal cap body 100 is low, this may deform the recess outwards instead of accomplishing the stretching of the liner 120. To prevent such a deformation, a reinforcing insert or structure 130 can be inserted into the top side of the recess 102, which may effectively fill and support recess 102 and allow the mandrel of the capping head to apply even pressure over the entire top-surface of the closure during application.

Structure 130 may include any material sufficiently rigid for supporting closure 100 during bottling; for example, structure 130 may include an injection molded disk, metal or wood disk, glass, wax, plastic, or the like. In some examples, the material and/or structure of closure 100 may be sufficient to cause liner 110 to deform without the aid of structure 130. Additionally, a capping head with a central extension of the head could similarly reinforce the center recess during application to push liner 120 into the bottle opening, without the need for support structure 130.

Closure 100 may be constructed from metal such as aluminum or steel that is impermeable to atmospheric air, and contains one or more openings, or ventilation holes, through which atmospheric air can pass to reach liner 120. In one embodiment, closure 100 is an aluminum screw cap closure for use with wine bottles. In another embodiment, closure 100 is a molded plastic cap that may feature a protrusion at the top-center in an identical form to the formed recess of the aluminum embodiment, but without the corresponding void on the other side or the consequential need for a reinforcing insert.

It should be noted, however, that other embodiments of the present invention may include liners that are fitted within bottle cap closures other than screw cap closures and bottle cap closures for bottles other than wine bottles.

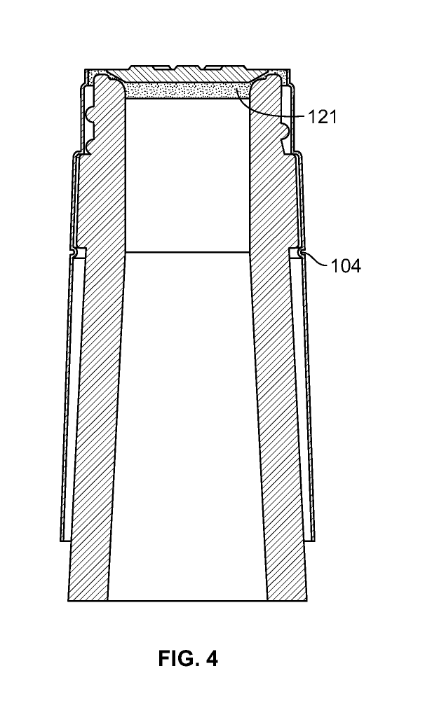

As shown in FIG. 3, in some examples, a partial or fully molded liner 122 may be used. Liner 121 may further be held in place with closure 100 via retaining grooves on the housing of closure 100 (exemplary retaining grooves shown in FIG. 4 and discussed below). Accordingly, the edges of the liner 121 can be positioned in the upper reaches of the cap, e.g., against the interior surface of the end portion of closure 100—while at the same time being able to accommodate the recess in the center via flexing or being shaped appropriately. In one example, this is accomplishing with the use of a liner that is fairly flexible without causing wrinkles, or a liner that is pre-formed to accommodate this geometry. Such a pre-form liner can be created by thermoforming a flat liner into a partial hemisphere, or by using an injection-molded or compression-molded insert that is appropriately shaped to accommodate these cap features.

Previously filed U.S. patent application Ser. No. 12/403,082, titled VENTED SCREWCAP CLOSURE WITH DIFFUSIVE MEMBRANE LINER, filed Mar. 12, 2009, for which the entire contents of which are incorporated herein by reference, describes a number of holes in the top of a screwcap closure body to assist with gas transfer, e.g., oxygen, through the screwcap. The recess from the instant patent application and the insert that goes inside it have an additional functional benefit of providing a place for these holes that is covered from external view.

The insert or support structure 130 may further be designed to allow air to access holes in the closure 100 by providing a pathway around the sides of the structure 130, holes through the bulk of the structure 130, via diffusion/permeation through the structure 130 material itself, combinations thereof, or the like.

According to one approach, liner 120 may be constructed such that a gas, such as oxygen, that diffuses through liner 120 moves along a path within liner 120 whose length is greater than the thickness of the liner 120. In this manner, a gas such as oxygen from the atmospheric air can diffuse through a relatively thin liner at a slow rate before reaching the bottle contents.

According to one approach, liner 120 may comprise two or more layers that include at least one semi-permeable layer and at least one impermeable layer. Semi-permeable layers may be constructed from materials that are semi-permeable to oxygen such that oxygen can diffuse through the semi-permeable layers. An example of a material that is semi-permeable to oxygen is polyester. Material for semi-permeable layers may also be slightly elastic so that the semi-permeable layers may be compressed in the areas where the liner is sandwiched between the rim of the bottle below and the screw cap closure above, and further able to stretch due to the recessed 102 being forced into the opening of the bottle. This elasticity fills any irregularities in the sealing surface and ensures a tight seal for the bottle.

Various materials and designs of closure 100 and liner 120 are described, for example, in U.S. patent application Ser. No. 12/403,082, referenced above.

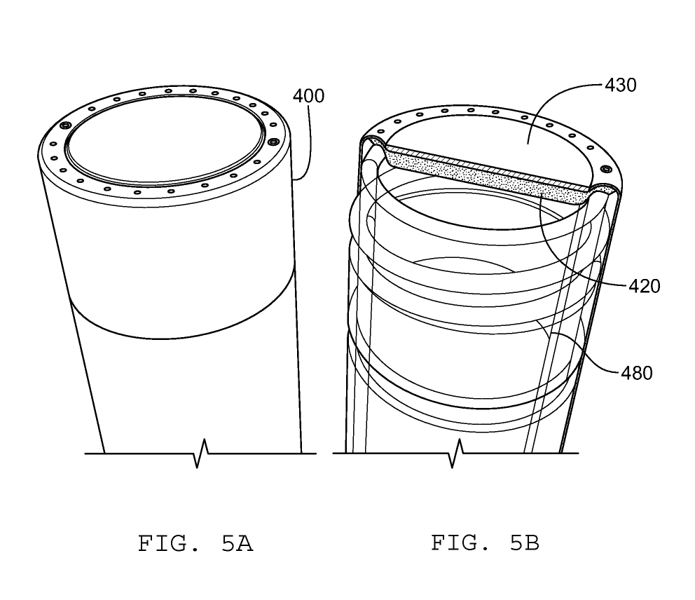

FIG. 5 illustrates a perspective view of an embodiment of a bottle closure 400 having a recessed liner 420 and a partial cut away of the bottle closure 400 positioned on a bottle neck 480.

Additionally, as seen in this example, the reinforcing structure 430 is shown in recess 402. In other examples, structure 430 could be a singular piece along with closure 400 if closure 400 were to be molded from a polymer or the like instead of drawn from sheet metal as shown.

Reinforcing structure 440 may further include passageways 444 formed therein to allow for the passage of air, for example, for use with semi-permeable liners. The passageways 444 shown circumferentially around structure 440 may allow air to pass there through to holes formed in closure 400 and to liner 420. Characteristics of the passageways, including the number, shape, length, etc., may be varied for different purposes.

It is further noted, that reinforcing structure 440 may further play a decorative role for the closure 400. The appearance of such an insert or structure 440 can be made similar to the traditional practice of placing a small amount of molten wax on top of a cork, and the insert could be modified to bear a winery's logo, a vintage date, or any desired adornment including printed material adhered to the exterior of the insert.

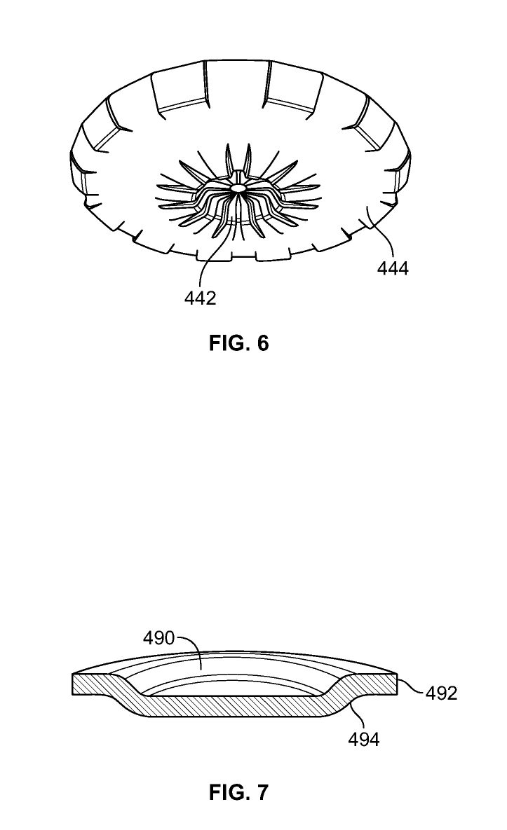

In one example, as seen in FIG. 6, reinforcing structure 440 may further include a counter-recess in the middle of the reinforcing structure 440, which will mate closely to a similar node in the center of the recess in closure 400. This will ensure that the insert is centered upon application and during the bottling process.

FIG. 7 illustrates a cross-sectional view of one embodiment of liner 420 in greater detail. In this example, liner 420 includes a formed liner having a recess portion 490. Recess portion 490 may be sized to fit with a recessed portion of a closure, and also to provide improved stretching and sealing during use. For example, edge portion 492 may be fixed within a groove or other structure of a closure as shown in FIG. 4, and intermediate portion 494 may stretch during bottling to contact the inner bore of the bottle and/or the upper lip of the bottle opening.

Although only certain exemplary embodiments have been described in detail above, those skilled in the art will readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

What is claimed as new and desired to be protected by Letters Patent of the United States is:

1. A bottle closure comprising:
a cap having a cylindrical shaped body and a closed end;
a liner disposed on an interior surface of the closed end of the cap, the liner for contacting a bottle opening, wherein the closed end of the cap further comprises a recess formed therein for urging a central portion of the liner into a bottle opening when applied thereto; and
a support structure disposed with the recess on an exterior surface of the closed end of the cap.

2. The bottle closure of claim 1, wherein the recess is centered with respect to the closed end of the cap and is .5 to 2 millimeters deep and .5 to 2 millimeters narrower in diameter than a lip of a bottle being capped.

3. The bottle closure of claim 1, wherein the recess is centered with respect to the closed end of the cap and is .5 to 2 millimeters deep and 1.5 to 15 millimeters narrower in diameter than the cylindrical shaped body of the cap.

4. The bottle closure of claim 1, wherein the cap is injected molded and the recess comprises a centrally placed mass for urging a central portion of the liner into the bottle opening when applied thereto.

5. The bottle closure of claim 1, wherein the recess has a semi-circular, ellipsoidal, trapezoidal, or rectangular cross-sectional profile.

6. The bottle closure of claim 1, wherein the support structure comprises plastic, glass, wax, adhesive, metal, paper, or cork.

7. The bottle closure of claim 1, wherein the support structure is operable to allow oxygen access to at least one hole formed in the cap and within the recess itself.

8. The bottle closure of claim 7, wherein the support structure provides a physical pathway for gas to reach the at least one hole.

9. The bottle closure of claim 7, wherein the support structure allows for the passage of gas permeation through the material of the support structure to the at least one hole.

10. The bottle closure of claim 7, wherein the liner is shaped such that is has lower clearance in the center thereof to accommodate the recess, and a higher clearance at the edges so as to fit into a retaining groove formed within the cap.

11. A bottle comprising a bottle closure as recited by claim 1.

12. A bottle closure comprising:
a cap having a cylindrical shaped body and a closed end; and
a liner disposed on an interior surface of the closed end of the cap, the liner for contacting a bottle opening, wherein the closed end of the cap further comprises at least one of a recess or central mass formed therein for urging a central portion of the liner into a bottle opening when applied thereto.

13. The bottle closure of claim 12, further comprising a support structure disposed with the at least one recess or central mass on an exterior surface of the closed end of the cap.

14. A method for capping a bottle, comprising:
disposing a cap having a cylindrical shaped body and a closed end over a bottle opening, the closed end having at least one of a recess or central mass formed therein, and the cap further comprising a liner disposed on an interior surface of the closed end; and
urging the cap against the bottle opening such that a central portion of the liner contacts inner walls of the bottle opening.

15. The method of claim 14, further comprising urging the cap with a press having a feature to support the at least one of a recess or central mass.

16. The method of claim 14, wherein the at least one of a recess or central mass comprises a recess centered with respect to the closed end of the cap and is .5 to 2 millimeters deep and .5 to 2 millimeters narrower in diameter than a lip of a bottle being capped.

17. The method of claim 14, wherein the at least one of a recess or central mass comprises a recess centered with respect to the closed end of the cap and is .5 to 2 millimeters deep and 1.5 to 15 millimeters narrower in diameter than the cylindrical shaped body of the cap.

18. The method of claim 14, wherein the support structure is operable to allow oxygen access to at least one hole formed in the cap and within the recess itself.

19. The method of claim 18, wherein the support structure provides a physical pathway for gas to reach the at least one hole.

20. The method of claim 18, wherein the support structure allows for the passage of gas permeation through the material of the support structure to the at least one hole.

21. The method of claim 18, wherein the liner is shaped such that is has lower clearance in the center thereof to accommodate the recess, and a higher clearance at the edges so as to fit into a retaining groove formed within the cap.
